(19) United States
(12) Patent Application Publication
(10) Pub. No.: US 2019/0309921 A1
(43) Pub. Date: Oct. 10, 2019

(54) HEADLIGHT LENS FOR A MOTOR VEHICLE HEADLIGHT

(71) Applicant: DOCTER OPTICS SE, Neustadt an der Orla (DE)

(72) Inventors: Manuel TESSMER, Jena (DE); Mohsen MOZAFFARI-AFSHAR, Gera (DE); Siemen KÜHL, Jena (DE)

(21) Appl. No.: 16/314,928

(22) PCT Filed: Jun. 9, 2017
(86) PCT No.: PCT/EP2017/000677

§ 371 Date: Jan. 3, 2019

(30) Foreign Application Priority Data
Jul. 27, 2016 (DE) 10 2016 009 067.7

(51) Int. Cl. F21S 41/275; F21S 41/143; F21S 41/155; F21S 41/255; F21S 41/27; F21S 41/20

(52) U.S. Cl. CPC F21S 41/275; F21S 41/143; F21S 41/285; F21S 41/255; F21S 41/27; F21S 41/155

(57) ABSTRACT

A monolithic headlight lens is provided for a vehicle headlight with a light source, for example for a motor vehicle headlight, wherein the headlight lens includes a light entry face and a light exit face through which light that has entered into the light entry face exits from the headlight lens with a bright-dark boundary (HDG) without the headlight lens including any optical structure that is imaged as a bright-dark boundary (HDG).

### CROSS-REFERENCE TO RELATED APPLICATIONS

This application is a U.S. national counterpart application of international application serial No. PCT/EP2017/000677, filed Jun. 9, 2017, which claims priority to German Patent Application No. 102016009067.7 filed Jul. 27, 2016.

### FIELD OF THE INVENTION

The invention relates to a headlight lens for a vehicle headlight, for example a motor vehicle headlight, and to a vehicle headlight. The invention furthermore relates to a method of manufacturing a headlight lens or a motor vehicle headlight.

### BACKGROUND

Headlight lenses are employed, for example, in projection-type headlights for motor vehicles and special-purpose vehicles. According to the “Kraftfahrtechnisches Taschenbuch”—Bosch, 22nd edition, ISBN 3-540-62219-5, pages 704-707, for example the last picture on page 707, such headlights are also referred to as PES headlights. Here, a shutter is arranged between a light source and a headlight lens, the shutter having an upper edge which is imaged as a bright-dark boundary by means of the headlight lens.

DE 10 2004 043 706 A1 discloses an optical system for a motor vehicle headlight for distributing a light beam bundle of a lamp, wherein a primary optical element having an optical face with a discontinuity extending along a line is provided, wherein the optical face is smooth at least on one side adjacent to the discontinuity so that the light beam bundle is divided into two partial light beam bundles. Here, at least one of the partial light beam bundles has a sharp boundary edge which is imaged onto a predetermined bright-dark boundary by means of an optical secondary element.

EP 1 630 576 A2 discloses a headlight with a light source and a secondary lens arranged subsequent of the light source in a direction of beam, wherein a primary optical element with a light entry and a light exit is arranged between the light source and the secondary lens, which is designed such that an emission characteristic corresponding to a provided emission characteristic is generated by means of the secondary lens by selective reflections in the primary optical element and a selective projection of the light exit or an imaginary face located in a beam path of the light emitted by the light source.

WO 2015/061822 A1 discloses an illumination device for a motor vehicle headlight wherein the illumination device comprises at least one optical body and at least one mounting device for the at least one optical body, wherein the at least one optical body comprises a number of adjacently arranged auxiliary optical systems, each auxiliary optical system comprising a face for coupling in light and a face for coupling out light, wherein the at least one mounting device comprises at least one seat for each auxiliary optical system, and wherein the seats are defined by boundary walls, wherein the boundary walls comprise, on the side of the light exit, boundary edges which are imaged in a light distribution created by the at least one optical body as bright-dark edges between the partial light distributions created by the individual auxiliary optical systems, and wherein a secondary projection lens is arranged subsequent of the at least one optical body in a light exit direction.

### SUMMARY

An embodiment concerns a monolithic headlight lens for a vehicle headlight with a light source, for example for a motor vehicle headlight, wherein the headlight lens comprises a light entry face and a light exit face through which light that has entered into the light entry face exits from the headlight lens (with a bright-dark boundary or generating a bright-dark boundary), wherein
the light exit face has no discontinuity, and/or
the light entry face has no discontinuity, and/or
the light exit face is differentiable at least twice, and/or
the light entry face is differentiable at least twice, and/or
the headlight lens has no (optical) structure (such as a bend according to WO 2012/072188 A1) that is imaged as a bright-dark boundary.

In an embodiment of the invention, the headlight lens consists of inorganic glass. Inorganic glass in the sense of the disclosure is for example silicate glass. Inorganic glass in the sense of the disclosure is for example glass as it is described in PCT/EP2008/010136. Inorganic glass in the sense of the disclosure for example comprises:
0.2 to 2 weight percent of Al₂O₃,
0.1 to 1 weight percent of Li₂O,
0.3, for example 0.4, to 1.5 weight percent of Sb₂O₃,
60 to 75 weight percent of SiO₂,
3 to 12 weight percent of Na₂O,
3 to 12 weight percent of K₂O, and
3 to 12 weight percent of CaO.

In a further embodiment of the invention, the headlight lens is limited by a marginal area between the light entry face and the light exit face, wherein the marginal area is not provided as a TIR face. In this sense, the headlight lens is for example no light conductor in which light distribution is generated by TIR and then exits from a light exit face. The bright-dark boundary is for example exclusively generated by (the relation between the light entry face and) the light exit face, wherein neither a shutter nor any optical structure for generating a bright-dark boundary, or which is imaged as a bright-dark boundary, is provided.

It may be intended that a light entry face in the sense of the disclosure and/or a light exit face in the sense of the disclosure comprises a light scattering structure. A light scattering structure in the sense of the disclosure may be e. g. a structure as it is disclosed in DE 10 2005 009 556 Al and EP 1 514 148 A1 or EP 1 514 148 B1.

Another embodiment concerns a vehicle headlight comprising a headlight lens including one or several ones of the aforementioned features, wherein the vehicle headlight does not comprise any secondary optical system for imaging the headlight lens or the light exit face of the headlight lens or a light beam exiting from the light exit face of the headlight lens. The vehicle headlight moreover comprises a light source for irradiating light into the light entry face. A light source in the sense of the disclosure may comprise an actual light source or a light source with a reflector. It may be intended that the light source is connected with the light entry face or that the light entry face is coated with the light source. It may also be intended that the light source is arranged following the contour of the light entry face at a small distance from the light entry face. A small distance in this sense may be, for example, a distance of no more than 2 mm or no more than 1 mm.

A light source in the sense of the disclosure is for example a surface light emitter or for example a directed surface light emitter. A light source in the sense of the disclosure is e. g. an LED layer or an OLED layer. A light source in the sense of the disclosure is for example a directed layer or light source, a directed LED, or a directed OLED. A suited layer or light source is disclosed, for example, in WO 2008/121414 A1 (incorporated by reference in its entirety). A light source in the sense of the disclosure e. g. comprises a transparent electrode and an, for example reflective, electrode. Between the transparent electrode and the, for example reflective, electrode, for example a light-emitting layer or a light layer is arranged which comprises, for example, a first region comprising an organic emitting material, and a second region comprising a low-index material having an index of refraction that is smaller than the index of refraction of the (organic) emitting material, wherein the second region is arranged adjacent to the first region. In an embodiment, the low-index material has an index of refraction of 1.0 to 3.0. In a further embodiment of the invention, the low-index material has an index of refraction of 1.0 to 1.5. In a further embodiment of the invention, the low-index material forms a grid which is oriented in a plane parallel to the transparent electrode and to the (reflective) electrode. In a further embodiment of the invention, the grid is designed with a periodicity that is greater than the wavelength of light. In a further embodiment of the invention, the periodicity is not greater than five times the width of the grid lines. In a further embodiment of the invention, the periodicity is not greater than four times the width of the grid lines. In a further embodiment of the invention, the periodicity is not greater than three times the width of the grid lines. In a further embodiment of the invention, the low-index material consists of or comprises an aerogel, Teflon, graded thin-film SiO₂, graded thin-film TiO₂, and/or sheets of SiO₂ nanorods. A light source in the sense of the disclosure may be a FOLED. Examples of FOLEDS may be taken from WO 98/07173 (incorporated by reference in its entirety) and the Internet site oled.com/oleds/flexible-oleds-foleds/ (incorporated by reference in its entirety).

Another embodiment concerns a motor vehicle comprising a headlight lens with one or several ones of the aforementioned features or a vehicle headlight with one or several ones of the aforementioned features.

Another embodiment concerns a method of manufacturing a headlight lens comprising one or several ones of the aforementioned features, wherein a light entry face of the headlight lens and a light source for irradiating light into the light entry face are selected, wherein a light distribution (flux density or intensity distribution) is selected on a target face onto which the light of the light source is directed by means of the headlight lens, wherein the light (or its flux density or intensity distribution) entering into the light entry face of the headlight lens (for example by means of a Jacobian matrix or the determinant of the Jacobian matrix) is related to the light distribution (flux density or intensity distribution) on the target face in the form of a differential equation, and wherein the differential equation is resolved for a coordinate describing the shape of the light exit face of the headlight lens.

An aforementioned light distribution is for example an intensity distribution. Intensity or intensity distribution refers to power or luminous power. Power is to be understood as energy per area and time unit. Power in the sense of the disclosure is for example the flux density.

It is for example intended that the desired light distribution on the target face comprises a bright-dark boundary limiting the light to the top. It is for example intended that the bright-dark boundary comprises at least one bend, for example at least two bends.

In a further embodiment of the invention, a surface of the headlight lens between the light entry face and the light exit face that connects the light entry face and the light exit face is selected, wherein it is for example intended that the surface is not provided or equipped as a TIR surface.

In a further embodiment of the invention, the differential equation is a second-order differential equation.

In a further embodiment of the invention, a headlight lens whose light entry face corresponds to the selected light entry face and whose light exit face corresponds to the calculated light exit face is manufactured.

In a further embodiment of the invention, a mold having a first mold face for molding a surface corresponding to the (negative of the) selected light entry face of the headlight lens, and having a second mold face for molding a surface corresponding to the (negative of the) calculated light exit face of the headlight lens is manufactured, wherein a headlight lens is pressed by means of the mold. Here, it is for example intended that a blank or a gob is heated or its temperature gradient is reversed, and the hot gob is press-molded between the two molds. The blank or the gob for example consists of inorganic glass.

A motor vehicle in the sense of the disclosure is for example a land craft to be individually used in road traffic. Motor vehicles in the sense of the disclosure are for example not restricted to land crafts with an internal combustion engine.

### BRIEF DESCRIPTION OF THE FIGURES

FIG. 1 shows an exemplified embodiment of a method of manufacturing a headlight lens for a vehicle headlight or a motor vehicle headlight and of a method of manufacturing a corresponding headlight;

FIG. 2 shows an exemplified embodiment of a headlight lens manufactured by means of the method according to FIG. 1;

FIG. 3 shows a bright-dark boundary generated by means of the headlight lens according to FIG. 2;

FIG. 4 shows an alternative method of manufacturing a headlight lens or a headlight;

FIG. 5 shows the illuminated image in response to the relative source size;

FIG. 6 shows an exemplified embodiment of a headlight lens resulting after having undergone step 16 according to FIG. 4;

FIG. 7 shows an exemplified embodiment of a configuration for simulating the light distribution of the headlight lens with the selected light entry face according to FIG. 6 and the determined light exit face in connection with a non-punctiform light source;

FIG. 8 shows an exemplified embodiment of a headlight lens resulting after having undergone step 16 according to FIG. 4;

FIG. 9 shows an exemplified embodiment of a configuration for simulating the light distribution of the headlight lens with the modified light entry face according to FIG. 8 and the determined light exit face in connection with the non-punctiform light source;

FIG. 10 shows an exemplified embodiment of a headlight lens resulting after having undergone step 16 according to FIG. 4 again;

FIG. 11 shows an exemplified embodiment of a configuration for simulating the light distribution of the headlight lens with the modified light entry face according to FIG. 10 and the determined light exit face in connection with the non-punctiform light source;

FIG. 12 shows a further exemplified embodiment of a headlight lens manufactured according to the disclosure;

FIG. 13 shows a further alternative method of manufacturing a headlight lens or a headlight;

FIG. 14 shows an exemplified embodiment of a headlight lens resulting after having undergone step 26 according to FIG. 13;

FIG. 15 shows an exemplified embodiment of a headlight lens after having undergone step 28 according to FIG. 13;

FIG. 16 shows an exemplified embodiment of an initial configuration for taking into consideration a tilted or oblique fitting position of a headlight lens in a motor vehicle; and

FIG. 17 shows an exemplified embodiment of a method of manufacturing a motor vehicle.

### DETAILED DESCRIPTION

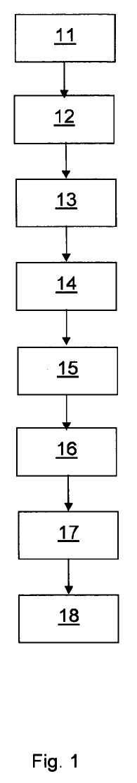

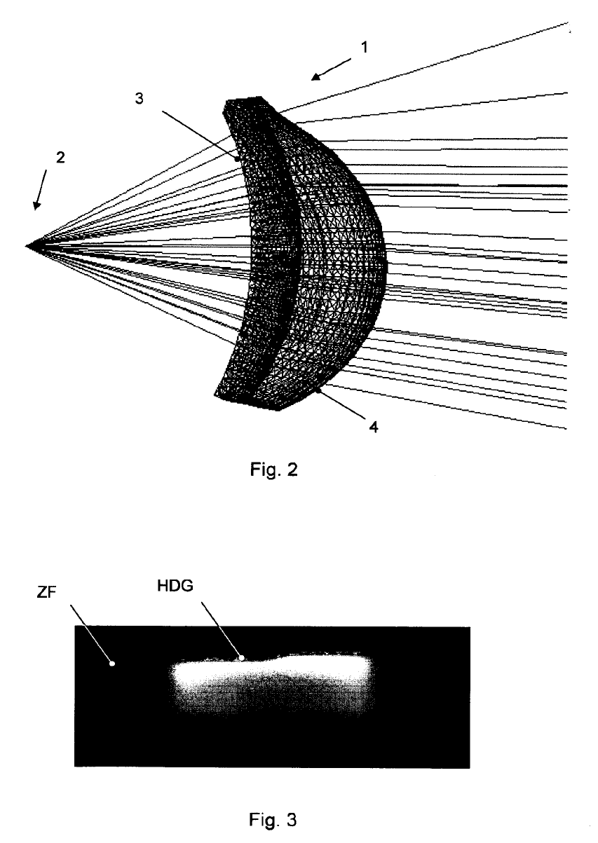

FIG. 1 shows a method of manufacturing a headlight lens 1 represented in FIG. 2 for generating a bright-dark boundary HDG represented in FIG. 3. The headlight lens comprises a light entry face 3 and a light exit face 4 through which light entering into the light entry face 3 in the headlight lens 1 exits. Neither the light entry face 3 nor the light exit face 4 have any discontinuity. Moreover, the light entry face 3 and the light exit face 4 are differentiable at least twice. The headlight lens 1 for example does not have any (optical) structure that is imaged as a bright-dark boundary. Moreover, no secondary optical system which images light that exits from the light exit face 4 is provided. The bright-dark boundary HDG is rather generated exclusively by the headlight lens 1 or (the relation between the light entry face 3 and) the light exit face 4, wherein light of a light source 2 is irradiated into the light entry face 3.

The method of manufacturing the headlight lens 1 described in FIG. 1 starts with a step 11 where a fictitious light source 2 in the form of a point light source is selected. A step 12 follows where the light entry face 3 of the headlight lens 1 is selected such that the light beams of the fictitious point light source 2 enter through the light entry face 3 into the headlight lens 1 perpendicularly to the respective point of the light entry face 3.

A step 13 follows where a target face ZF to be illuminated (screen, wall) and the flux density or intensity distribution Oₒᵤₜ(X,Y) to be achieved or that is desired on this target face ZF are selected (cf. for example ECE R112), wherein X and Y are the coordinates on the target face. The flux density or intensity distribution Iₒᵤₜ(X, Y) to be achieved or that is desired is here selected such that the light impinges on the target face ZF (essentially) below a bright-dark boundary. It may also be intended that the coordinates are stated as polar coordinates. This is for example if the desired light distribution is selected in the sense of ECE R112.

A step 14 follows where the flux density or the intensity distribution of the light that enters into the light entry face 3 of the headlight lens 1 is related with the flux density or intensity distribution on the target face ZF by means of a Jacobian matrix in the form of a differential equation:

Iₒᵤₜ(X,Y)·|J|=Iᵢₙ(x,y)

wherein the Jacobian matrix is

$$J = [ \begin{matrix}{\partial }_{x} X & {\partial }_{y} X \\ {\partial }_{x} Y & {\partial }_{y} Y\end{matrix} ]$$

The coordinates X and Y are a function of x, y, ∇z, wherein ∇ designates the 2-D gradient. That means ∇z is the gradient of the surface function z=z(x,y) in Cartesian coordinates, and r=r(ϕ,θ) in spherical coordinates. The place R=(X, Y) of the impingement of a light beam onto the target face ZF depends on the index of refraction and the oblique position of the light exit face 4 of the headlight lens 1, wherein the oblique position of the light exit face 4 is characterized by the 2-D gradient so that the following second-order differential equation results:

Iₒᵤₜ(x,y,∇z)·|J(x,y,∇²z)|=Iᵢₙ(x,y)

Here, the first derivation indicates where the light impinges on the target face ZF, and the second derivation, which corresponds to the curvature of the face, indicates how much light impinges on the target face at said point.

A step 15 follows where the second-order differential equation (Monge-Ampère equation) is resolved for z

Iₒᵤₜ(x,y,∇z)·|J(x,y,∇²z)|=Iᵢₙ(x,y)

The function z(x,y) defines the light exit face 4 of the headlight lens 1 (cf. e. g. Adam M. Oberman: “Convergent difference schemes for degenerate elliptic and parabolic equations: Hamilton-Jacobi equations and free boundary problems”, SIAM J. Numer. Anal., 44:879-895, 2006; Froese, B. D.: “A numerical method for the elliptic Monge-Ampère equation with transport boundary conditions”, SIAM J. Sci. Comput., 34, 2012; B. D. Froese, A. M. Oberman: “Convergent finite difference solvers for viscosity solutions of the elliptic Monge-Ampère equation in dimensions two and higher”; SIAM Journal on Numerical Analysis, 49, January 2011; J.-D. Benamou, B. D. Froese, A. M. Oberman: “Numerical solution of the Optimal Transportation problem using the Monge-Ampère equation”, Journal of Computational Physics, 260, March 2014).

In a following step 16, a marginal area between the margin of the light entry face 3 and the margin of the light exit face 4 is selected, insofar as the margins of the light entry face 3 and the light exit face 4 do not touch.

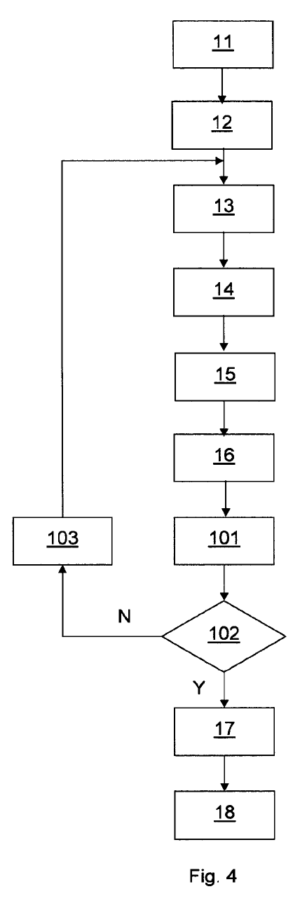

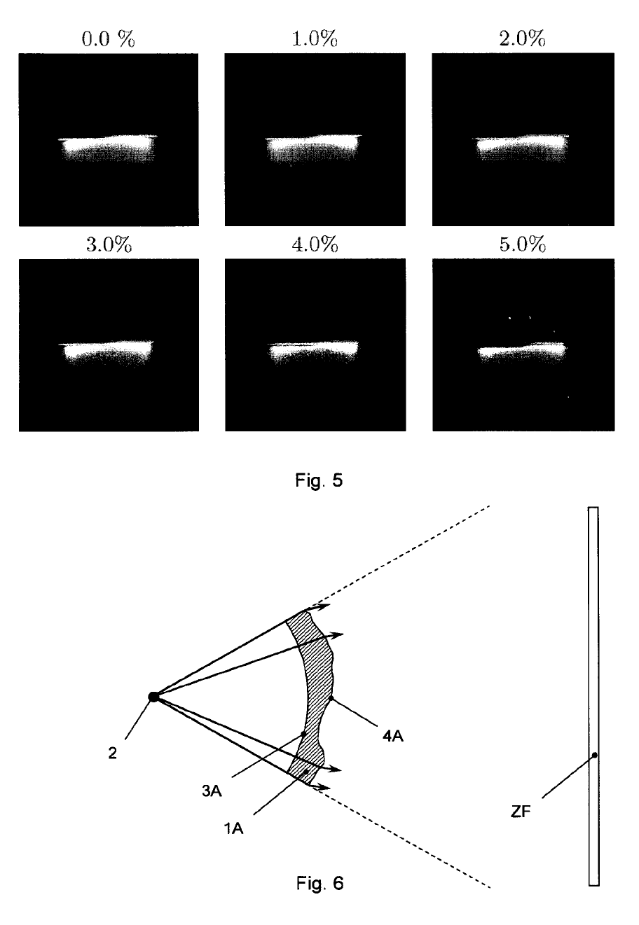

In a subsequent step 17, a headlight lens 1 with the selected light entry face 3 and the determined light exit face 4 is manufactured or produced, respectively. In a subsequent step 18, the headlight lens 1 is installed in a low-beam vehicle headlight together with a non-punctiform light source whose light enters into the light entry face 3 and exits through the light exit face 4 from the headlight lens 1. Here, for example a modified method represented in FIG. 4 is employed where step 16 is not followed by step 17, but by step 101 where the light distribution of the headlight lens 1 is simulated with the selected light entry face 3 and the determined light exit face 4 in connection with a non-punctiform light source. It is for example intended that the non-punctiform light source is a quadrangular, for example square light source, such as, for example, an LED. The result of the corresponding simulations is shown in FIG. 5. Here, FIG. 5 shows the illuminated image in response to the relative source size, i. e. the ratio of the size of the non-punctiform light source to the light entry face 3. The efficiency is, with respect to the selected exemplified embodiment, in each case about 93%. The corresponding illuminated image is checked in view of its light-related properties and the fulfillment of the light-related values, such as e. g. the light-related values according to ECE R112 (query 102). If the desired light-related values are not fulfilled, step 103 follows query 102, where the light entry face is enlarged. Step 103 is in turn followed by step 13. If the light-related values, however, are fulfilled, step 17 follows query 102.

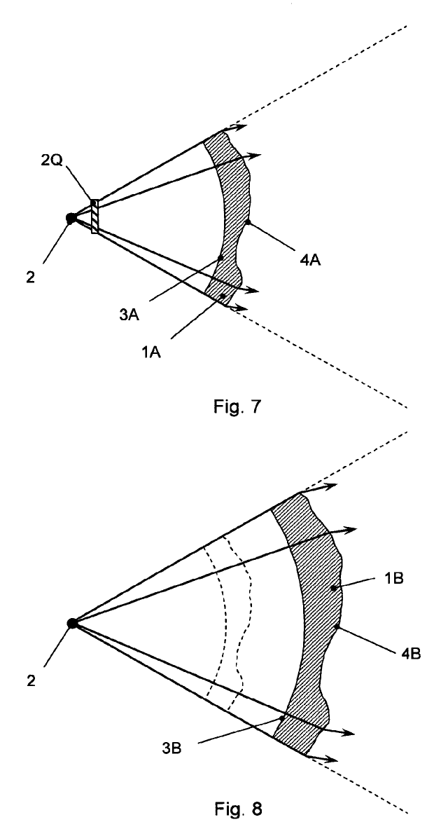

The modified method according to FIG. 4 will be illustrated below with reference to FIGS. 6 to 11. Here, FIG. 6, for example, shows the headlight lens 1A with the light exit face 4A initially resulting with a selected light entry face 3A. In step 101, the desired non-punctiform light source 2Q is added —as is represented in FIG. 7—and the headlight lens 1A is simulated together with the light source 2Q which has, in the present exemplified embodiment, a relative source size of 4% (cf. FIG. 5). Here, the light distribution designated with a source size of 4% according to FIG. 5 results in the employed exemplified embodiment, which is judged as not being sufficient for this example by means of query 102. Therefore, step 103 follows where the light entry face is enlarged.

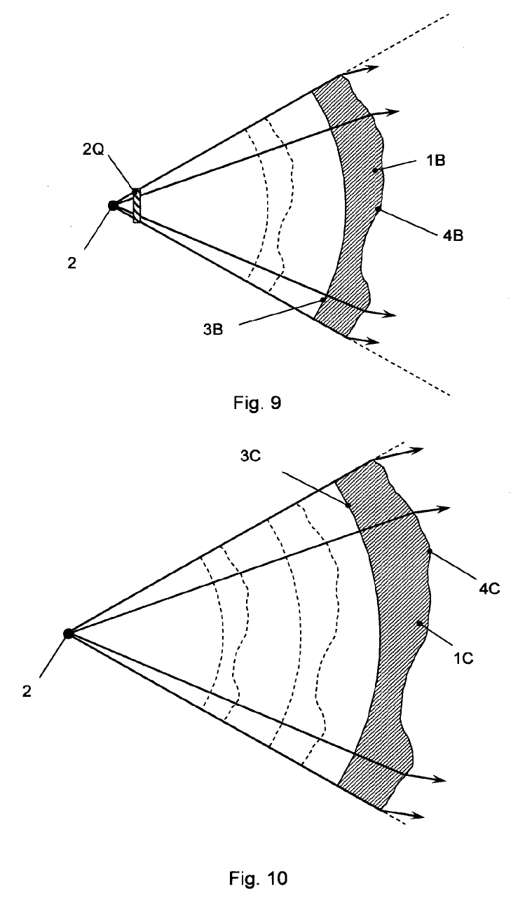

The enlarged light entry face is represented in FIG. 8 and designated with reference numeral 3B. After steps 13, 14, 15 and 16 have been carried out, the headlight lens 1B with the light exit face 4B is obtained. In step 101, the desired non-punctiform light source 2Q is added—as is represented in FIG. 9—and the headlight lens 1B is simulated together with the light source 2Q which now has, in the present exemplified embodiment, a relative source size of 3% (cf. FIG. 5). Here, the light distribution designated with a source size of 3% according to FIG. 5 results in the employed exemplified embodiment, which is judged as not being sufficient for this example by means of query 102. Therefore, step 103 follows again, where the light entry face is enlarged.

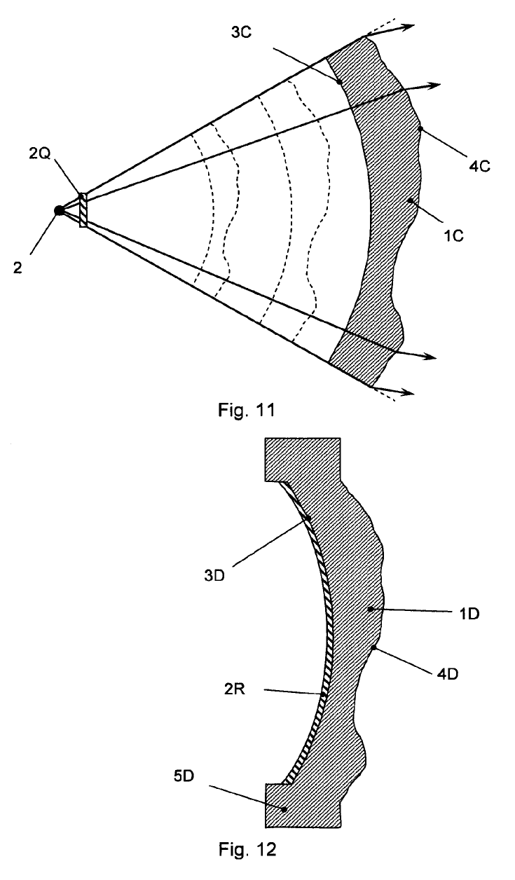

The enlarged light entry face is represented in FIG. 10 and designated with reference numeral 3C. After the steps 13, 14, 15 and 16 have been carried out, the headlight lens 10 with the light exit face 4C is obtained. In step 101, the desired non-punctiform light source 2Q is added—as is represented in FIG. 11—and the headlight lens 10 is simulated together with the light source 2Q which now has, in the present exemplified embodiment, a relative source size of 2% (cf. FIG. 5). Here, the light distribution designated with a source size of 2% according to FIG. 5 results in the employed exemplified embodiment, which is judged as being sufficient for this example by means of query 102. Therefore, step 17 follows where the headlight lens 10 is manufactured and installed, in a step 18, together with the light source 2Q into a headlight.

FIG. 12 shows an alternative headlight concept where a headlight lens 1D corresponding to the headlight lens 1 is manufactured or press-molded with an for example circumferential assembly edge 5D. The light exit face of the headlight lens 1D is designated with reference numeral 4D. The light entry face 3D of the headlight lens 1D is provided with a light source 2R. The light source 2R may be, for example, a flexible OLED (FOLED) or a flexible LED, as it is disclosed, for example, in WO 98/07173 (incorporated by reference in its entirety), and on the Internet site oled.com/oleds/flexible-oleds-foleds/) (incorporated by reference in its entirety). It may be intended, however, that the light source 2R is manufactured onto the light entry face 3D. A manufacture of light-emitting layers onto curved faces may be accomplished analogously to the method described in EP 1 949 471 B1 (incorporated by reference in its entirety) for manufacturing a camera.

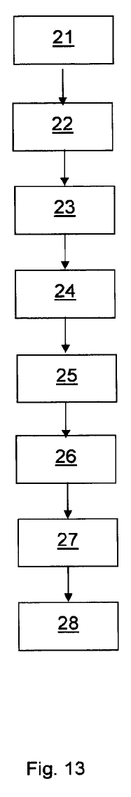

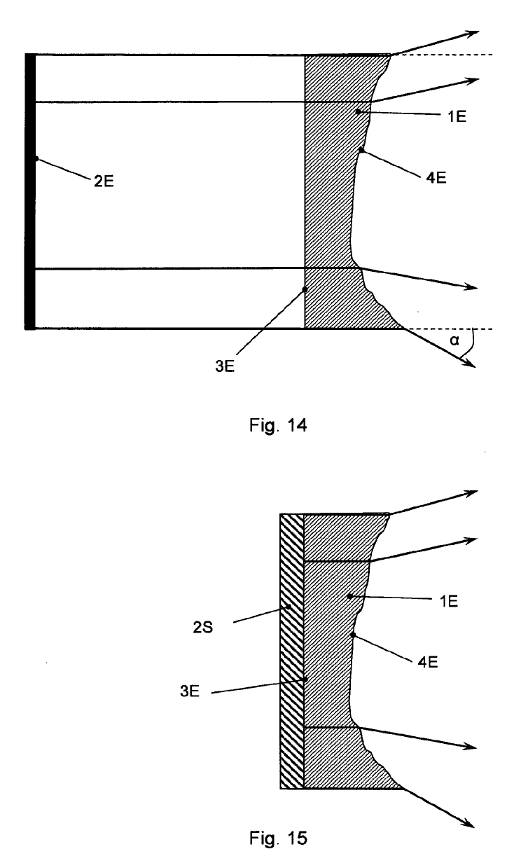

FIG. 13 shows a method as an alternative to the method according to FIG. 1 or to the method according to FIG. 4 of manufacturing a headlight lens for generating a bright-dark boundary HDG without any discontinuity or (optical) structure or shutter or the like being imaged. Here, in a step 21, a light source is selected which is a surface light emitter which irradiates (parallel or collimated) light into one (single) direction. A step 22 corresponding to step 12 follows where a plane face is selected as the light entry face 3E, cf. FIG. 14. The steps 23, 24, 25 and 26 following step 22 analogously correspond to steps 13, 14, 15 and 16, wherein, however, instead of a point light source, a light source 2E which irradiates collimated light into the light entry face 3E is assumed. After the steps 23, 24, 25 and 26 have been carried out, the headlight lens 1E with the light exit face 4E shown in FIG. 14 results. Here, FIG. 14 shows the headlight lens 1E in a cross-section in the x-z plane, where the x-axis is the vertical axis and the z-axis is the horizontal axis corresponding to the optical axis of the headlight lens 1E. For the angle α between the optical axis and the outer marginal ray of the light, the following applies:

$$\frac{{z}_{Schirm} - {z}_{Linse}}{{x}_{Schirm} - {x}_{Linse}} = tan α$$

(with Schirm=screen, Linse=lens) The increase of the light exit face 4E at the margin thus results in:

n₂ sin α=n₁ sin(π+arctan m)

with m being the increase in the x-direction, n₂ the index of refraction of the material of the headlight lens, and n₁ the index of refraction of air. The thickness of the headlight lens is irrelevant.

Step 27 follows where the headlight lens 1E is manufactured with the light entry face 3E and the light exit face 4E. In a subsequent step 28, the headlight lens 1 is installed in a low-beam vehicle headlight together with a light source designed as a surface light emitter whose light enters into the light entry face and exits from the headlight lens through the light exit face.

FIG. 15 shows an exemplified embodiment of a correspondingly resulting headlight, wherein the surface light emitter is a light source designated as light source 2S which is directly applied onto the light entry face 3E.

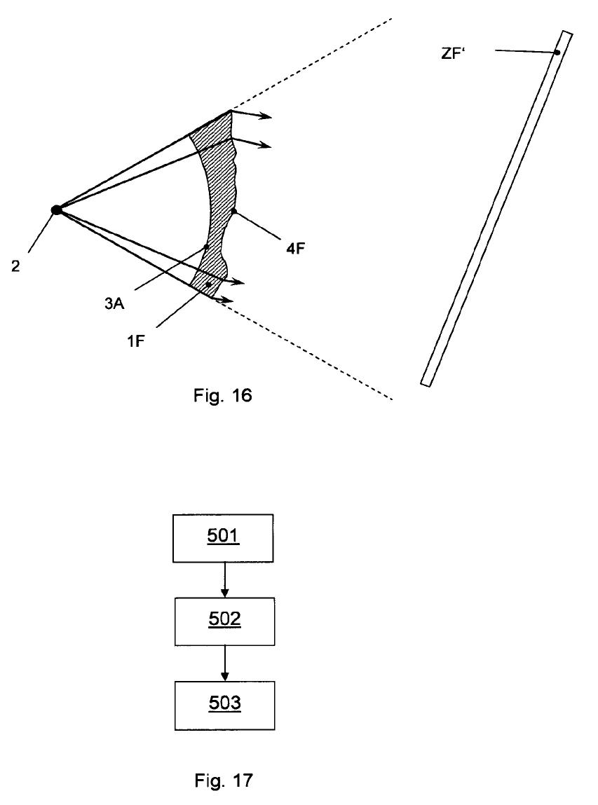

It may be intended to consider an oblique fitting position in a motor vehicle when determining the light exit face. Correspondingly, FIG. 16 shows, in variation to the configuration according to FIG. 6, an exemplified embodiment of an initial configuration for taking into consideration a tilted or oblique fitting position of a headlight lens in a motor vehicle. To this end, the light entry face 3A and the target face are tilted with respect to each other corresponding to the later fitting position. In the represented example, the target face ZF′ is tilted with respect to the light entry face 3A. However, a reversed case is also possible. Corresponding to the described procedure, a headlight lens 1F with the light entry face 3A and the light exit face 4F is determined. FIG. 17 shows an exemplified embodiment of a corresponding method of manufacturing a motor vehicle. Here, in a step 501, the fitting position of the headlight lens or a corresponding headlight in the motor vehicle is determined. Step 501 is followed by a step 502 which comprises one of the methods according to FIG. 1, 4 or 13. The correspondingly produced or manufactured headlight is installed into a motor vehicle in a subsequent step 503.

The arrows in FIGS. 6, 7, 8, 9, 10, 11, 14, 15 and 16 symbolize light beams. For a better overview, the target faces in FIGS. 7, 8, 9, 10, 11, 14 and 15 are not represented. The elements and layers in the Figures are drawn taking into consideration simplicity and clarity, and are not necessarily drawn to scale. For example, the dimensions of some elements or layers are represented in a clearly exaggerated manner with respect to other elements or layers to enhance the understanding of the exemplified embodiments of the present invention.

If in this application, reference is made to a light entry face or a light exit face, for example the contour of the light entry face or the contour of the light exit face is meant if no explicit reference is made to surface (micro-) structures as in the last but one paragraph on page 3.

Due to its low installation depth, headlights according to the invention are particularly suited to be installed in the vehicle's middle or in the middle third of the vehicle and/or in the shock absorber. Headlights according to the invention are particularly suitably installed, for example, at the positions 3001, 3002, 3003 and 3004 indicated in U.S. Pat. No. 9,243,769 B2 (incorporated by reference in its entirety).

The disclosure provides for a headlight lens for an alternative headlight concept. It for example desirable provides for a headlight concept or a headlight lens for such a headlight concept that differs from aforementioned headlight concepts. It furthermore for example provides for improved light efficiency or efficiency in the utilization of the luminous power of a light source. It furthermore provides for a headlight concept that permits the reduction of manufacturing costs at least as compared to aforementioned headlight concepts, at least, however, as compared to conventional projection-type headlights or PES headlights.

1-10. (canceled)

11. A vehicle headlight comprising
a headlight lens comprising
a light entry face and
a light exit face through which light irradiated into the light entry face exits from the headlight lens with a bright-dark boundary, the headlight lens being configured that the bright-dark boundary being exclusively generated by a relation between the light entry face and the light exit face; and
a light source for irradiating light into the light entry face.

12. The vehicle headlight of claim 11 wherein no shield being imaged as a bright-dark boundary is provided.

13. The vehicle headlight of claim 11 wherein no optical structure being imaged as a bright-dark boundary is provided.

14. The vehicle headlight of claim 11 wherein the vehicle headlight does not comprise any secondary optical system for imaging the headlight lens or the light exit face of the headlight lens.

15. The vehicle headlight of claim 11 wherein the headlight lens is limited by a marginal area between the light entry face and the light exit face, the marginal area not being provided as a TIR face.

16. The vehicle headlight of claim 13 wherein the headlight lens is limited by a marginal area between the light entry face and the light exit face, the marginal area not being provided as a TIR face.

17. The vehicle headlight of claim 16 wherein the light entry surface is concavely shaped.

18. The vehicle headlight of claim 11 wherein the light entry surface is concavely shaped.

19. The vehicle headlight of claim 11 wherein the light source is attached to the light entry surface.

20. The vehicle headlight of claim 16 wherein the light source is attached to the light entry surface.

21. The vehicle headlight of claim 11 wherein the light source is arranged following the contour of the light entry face at a distance from the light entry face

22. The vehicle headlight of claim 11 wherein the light source is arranged following the contour of the light entry face at a distance of no more than 2 mm from the light entry face.

23. A vehicle headlight comprising
a headlight lens comprising
a light entry face and
a light exit face through which light irradiated into the light entry face exits from the headlight lens with a bright-dark boundary, the headlight lens being configured that the bright-dark boundary being exclusively generated by the contour of the light exit face without the headlight lens comprising any optical structure that is imaged as a bright-dark boundary; and
a light source for irradiating light into the light entry face.

24. The vehicle headlight of claim 23 wherein no shield being imaged as a bright-dark boundary is provided.

25. The vehicle headlight of claim 23 wherein neither no optical structure being imaged as a bright-dark boundary is provided.

26. The vehicle headlight of claim 23 wherein the vehicle headlight does not comprise any secondary optical system for imaging the headlight lens or the light exit face of the headlight lens.

27. The vehicle headlight of claim 23 wherein the headlight lens is limited by a marginal area between the light entry face and the light exit face, the marginal area not being provided as a TIR face.

28. The vehicle headlight of claim 25 wherein the headlight lens is limited by a marginal area between the light entry face and the light exit face, the marginal area not being provided as a TIR face.

29. The vehicle headlight of claim 28 wherein the light entry surface is concavely shaped.

30. The vehicle headlight of claim 28 wherein the light source is attached to the light entry surface.

31. The vehicle headlight of claim 23 wherein the light source is attached to the light entry surface.

32. The vehicle headlight of claim 23 wherein the light source is arranged following the contour of the light entry face at a distance from the light entry face

33. The vehicle headlight of claim 23 wherein the light source is arranged following the contour of the light entry face at a distance of no more than 2 mm from the light entry face.

34. A vehicle having a headlight, the headlight comprising
a headlight lens comprising
a light entry face and
a light exit face through which light irradiated into the light entry face exits from the headlight lens with a bright-dark boundary, the headlight lens being configured that the bright-dark boundary being exclusively generated by a relation between the contour of the light entry face and the contour of the light exit face; wherein no optical structure being imaged as a bright-dark boundary is provided and a marginal area between the light entry face and the light exit face, the marginal area not being provided as a TIR face.
a light source for irradiating light into the light entry face.

35. The vehicle headlight of claim 11 wherein no shield being imaged as a bright-dark boundary is provided.

36. The vehicle of claim 34 wherein the light entry surface is concavely shaped.

37. The vehicle of claim 34 wherein the light source is attached to the light entry surface.

38. The vehicle of claim 34 wherein the headlight is integrated in a bumper of the vehicle.
